(19) United States
(12) Patent Application Publication
(10) Pub. No.: US 2008/0225358 A1
(43) Pub. Date: Sep. 18, 2008

(54) Original sheet support means in a scanner

(75) Inventors: Lourens A. Rijniers, Venlo (NL); W.J.E.G. Verhofstad, Vierlingsbeek (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Venlo (NL)

(21) Appl. No.: 12/076,096

(22) Filed: Mar. 13, 2008

Related U.S. Application Data
(60) Provisional application No. 60/907,003, filed on Mar. 16, 2007.

(51) Int. Cl. H04N 1/04

(52) U.S. Cl. 358/498

(57) ABSTRACT

A wide format transport scanner is provided with a drawer for holding a set of wide format original sheets to be scanned. The drawer is located immediately underneath the entry nip of the scanner. After placing a set of wide format originals on the drawer, the task of manually scanning an entire set of wide format originals one after another is facilitated to a great extent.

### CROSS-REFERENCE TO RELATED APPLICATIONS

This application claims priority under 35 U.S.C. § 119(e) to U.S. Provisional Application No. 60/907,003 filed on Mar. 16, 2007, the entirety of which is expressly incorporated herein by reference.

### BACKGROUND OF THE INVENTION

1. Field of the Invention

The present invention relates to an original sheet holder in a transport scanning system. In particular, the original sheet holder is for holding a set of original sheets for manually inserting one sheet at a time for scanning in the transport scanning system.

2. Description of Background Art

A transport scanner, which is also referred to as a feed through scanner, is a type of scanner, where an original is transported along a transport path through the scanning device, passing an input nip and further passing along an optosensitive array. The optosensitive array is mounted in the device fixedly and transversely with respect to the transport direction of the original. This in contrast with, e.g. a flat bed scanner, where the original is positioned fixedly on a platen and the optosensitive array will move relative to the platen.

Transport scanners are well suited for scanning wide format originals. In particular, but not by way of limitation, the original may have an appreciable size such as an A0 or A1 format, and may even stretch out in one direction, such as in the form of a semi-infinite roll. Since the large format has to be accommodated in only one dimension, the size of the device remains modest. There are no restrictions for the other dimension. On the other hand, an original sheet may also have quite a small size, which can also be accommodated.

Dependent on the position of the optosensitive array, a scanner may scan an original sheet face up or face down. If the array is positioned under the transport path, the bottom face of the original sheet will be scanned by the array. In this situation, an original sheet has to be entered face down, because the scanner will scan from the bottom of the original sheet. If the array is positioned above the transport path, the scanner will scan the top face of the original sheet. In this situation, the original sheet has to be entered face up, because the scanner will scan from the top of the original sheet.

An advantage of a face up scanner is that an operator can see the image on the original during placement of the sheet. Therefore, the operator is able to check whether or not an original is a misprint, an original is failing (in case of numbered originals) and whether or not an original has the right orientation for correct folder output. A disadvantage of a face up scanner is that the original set is delivered in the original delivery tray face up as well. If the operator started with the first original, the original set will be delivered in the wrong order in the original delivery tray. Many operators therefore start with an upside down set and rotate the original while putting it in the scanner.

Typical set sizes of originals to be scanned are 50-200 originals. No automatic document feeders exist for these formats. Moreover, wide format originals pose their own particular problems in the sense that these originals are not easy to handle by an operator. Most of the time, on a table beside the scanning device, a pile of original sheets to be scanned is available. During scanning of the set, the operator continuously has to pick one original from the table. This requires either walking or rotating his body towards the table back and forth. In addition, at the scanner, the original sheet has to be positioned properly against the input nip for pulling in of the original sheet and further transport of the original sheet along the optosensitive array. This has to be done accurately to prevent skewing. In the case of an unfolded A0 sheet, an operator must feed the sheet with both hands and without support. This is a cumbersome operation.

### SUMMARY OF THE INVENTION

To provide an operator with better support for manually scanning wide format originals in a transport scanning system, an original sheet holder holds a set of original sheets for manually inserting one original sheet at a time for scanning in the transport scanning system. The original sheet holder is positioned in such a way that leading edges of the original sheets on the original sheet holder are parallel to and in a direct vicinity of an entry nip of the transport scanning system and are directly accessible to an operator.

Once the pile or set of original sheets is placed on the original sheet holder, the operator can take the upper sheet of the set of original sheets and position it against the input nip with an easy movement. Then, after a short delay, the original sheet will be pulled in by the entry nip. There is no longer a need for the operator to rotate his body back and forth each time for picking an original sheet for scanning. The original sheet holder provides the operator with a more ergonomic working place.

Furthermore, during the positioning of the original sheet against the input nip, at least a portion of the original sheet will still be supported by the holder. Therefore, it will be easier to position the original sheet in an accurate manner, since an entirety of the original sheet is not hanging free without control, and the weight of the original sheet is not pulling against the subtle manual position movements needed to align with the input nip.

According to an embodiment of the present invention, the original sheet holder is positioned underneath the entry nip of the scanner. If the scanner is of the face down type, such an embodiment will combine advantages of both face up and face down scanner types.

The footprint of the device remains small if the original sheet holder is positioned above or beneath the original sheet entry and substantially within the footprint of the scanning device.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic cross-section of a transport scanner according to a first embodiment of the present invention;

FIG. 2 is a schematic cross-section of a transport scanner according to the first embodiment of the present invention with the drawer in an outward position;

FIG. 3 is a schematic cross-section of a transport scanner according to the first embodiment of the present invention with a set of original sheets for scanning;

FIG. 4 is a schematic cross-section of a transport scanner according to a second embodiment of the present invention; and

FIG. 5 is a schematic cross-section of a transport scanner according to a third embodiment of the present invention.

### DETAILED DESCRIPTION OF THE PREFERRED EMBODIMENTS

The present invention will now be described with reference to the accompanying drawings, wherein the same reference numerals have been used to identify the same or similar elements throughout the several views.

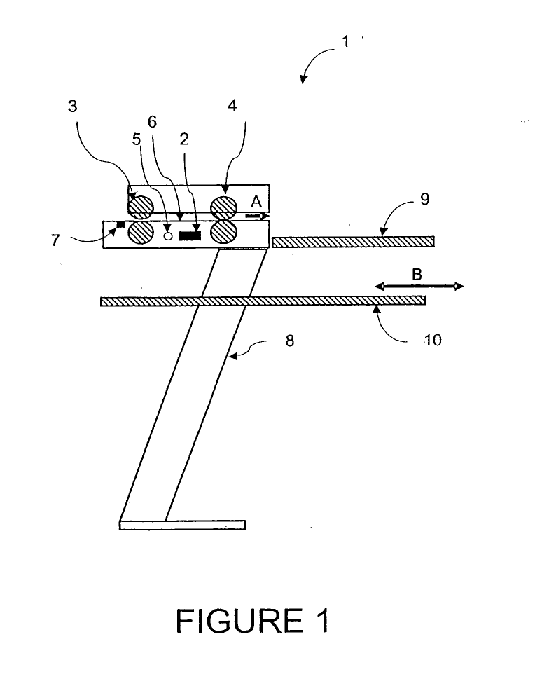

FIG. 1 is a schematic cross-section of a transport scanning system 1 according to a first embodiment of the present invention. The scanning system 1 includes an optosensitive array 2, two pairs of transport rollers 3 and 4, a light source 5, a platen 6, a sheet sensor 7 and two stands 8 (only one of the two stands 8 is shown in the FIG. 1). The two pairs of transport rollers 3 and 4 are provided for transporting an original sheet in the transport direction indicated with arrow A. Transport roller pair 3 forms an input nip. The platen 6 guides the original sheet along the optosensitive array. The sheet sensor 7 senses a sheet.

In operation, when an original sheet is positioned against the input nip by an operator, the sheet sensor 7 switches to an ON state. The roller pair 3 then, after a short delay, makes part of a turn in such a way that the sheet is pulled in a short distance. This will effectively free the hands of the operator. Further settings if needed (for example, adjustment of the sheet) can still be made at this point, since the original sheet has only been fed a short distance. After activation of the start button (not shown), the original sheet is transported along the platen 6 and the optosensitive array 2 and will be further transported by the pair of transport rollers 4 and delivered on original sheet delivery tray 9. When a subsequent original sheet is positioned against the input nip within a certain time interval there is no need to activate the start button again. The original sheet will be pulled in for scanning automatically. In this way, scanning of an entire set of original sheets can be easily accommodated.

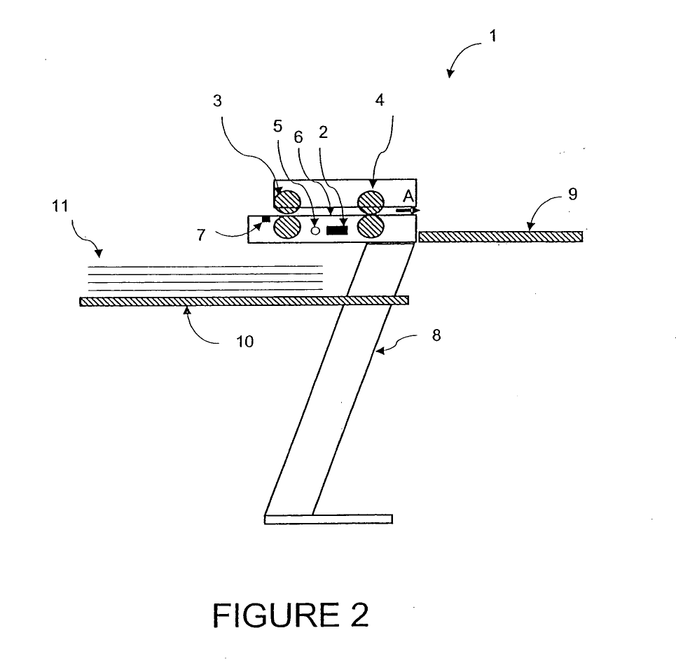

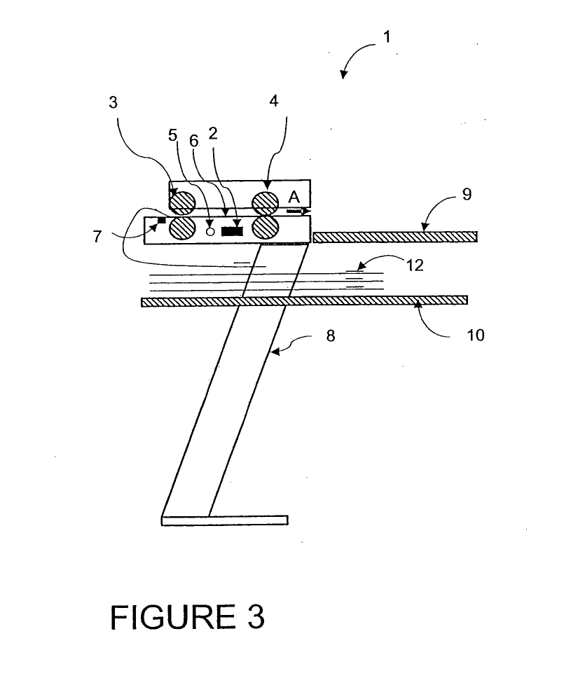

In this first embodiment of the present invention, the support mechanism is implemented as a drawer 10 that is slidable in a horizontal plane, as indicated by the arrow B. The drawer 10 is moved forward to enable the operator to put the set of original sheets 11 to be copied or to be scanned thereon. This is illustrated in FIG. 2. The configuration of the scanner shown in the figures is a face down scanning device. In this case, it is advantageous to place the set of original sheets 11 face up. The drawer is moved backwards so that the leading edges of the original sheets are substantially in the direct vicinity of the input nip. The operator takes the top sheet of the set of original sheets 11. The image on the original sheet is visible to the operator, because the original sheet is face up. The operator bends the sheet to position the leading edge of the original sheet against the input nip of the scanning device with the image on the original sheet face down. The sheet will be pulled in, scanned and fed through the scanner. This situation is illustrated in FIG. 3. The image side of an original sheet is indicated with reference numeral 12. Taking each time the uppermost sheet from the set of original sheets 11, the set is scanned in the correct order and delivered to the original sheet delivery tray 9 in the correct order as well.

Consideration of this embodiment and the way an operator is able to work with it, reveals, in a situation where original sheets are placed face up on the support mechanism, that before scanning, the image is visible and can be checked and that the set is delivered in the correct order to the original sheet delivery tray 9. There is no need to re-order the set of original sheets 11 after scanning or to rotate the set of original sheets 11.

This shows that the above configuration according to the present invention combines the advantages of a face up scanner with the advantages of a face down scanner. Furthermore, due to the support mechanism according to the present invention, the operator can pick the upper original sheet of the set of original sheets 11 and can put it in the scanner with an easy movement. The operator no longer has to rotate his body. This provides a more ergonomic working place.

The original sheet support mechanism according to the present invention can also be used with a face up scanner. However, if the support mechanism is positioned underneath the scanner, as is the case of the first embodiment, the set of original sheets 11 has to be put on the sheet support mechanism with the image face down, in order to get the images scanned and delivered in the correct order.

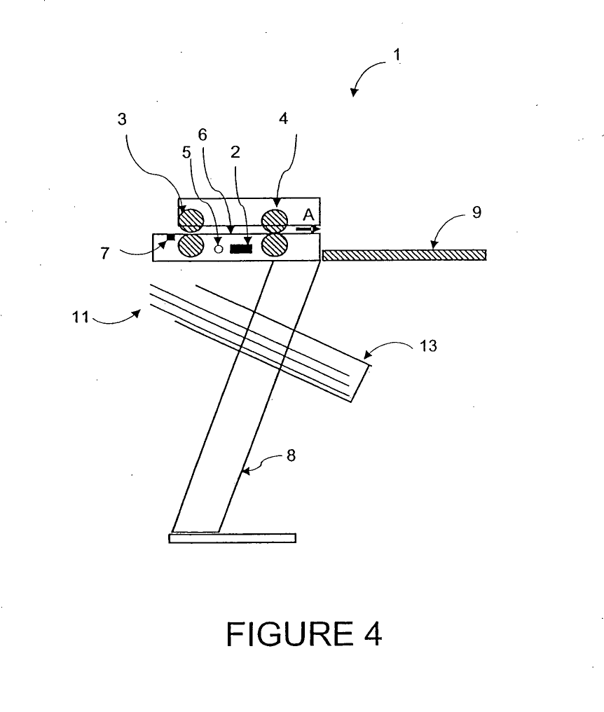

FIG. 4 is a schematic cross-sectional view of an alternative embodiment of the original sheet support mechanism of the present invention. In this embodiment, the original sheet support mechanism takes the form of a tilted container 13, suited to receive unfolded original sheets.

In the next exemplary embodiments, the scanning system comprises disjoined components.

In a first exemplary embodiment, the stand 8 is disjoined from the scanning device (table top device). In this case, the original sheet holder according to the present invention is a third disjoined component, that takes the form of a drawer enclosed in a frame or box, at least open at the front side, resting on the stand 8 and upon which the scanning device is placed.

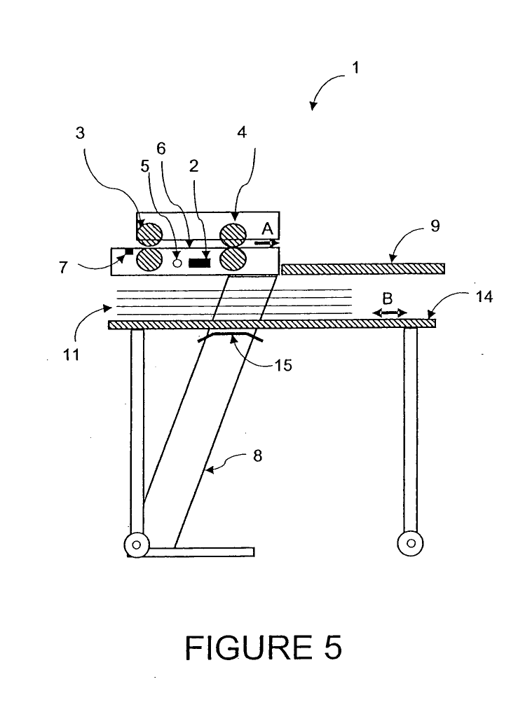

In a further exemplary embodiment, the original sheet holder is provided as a movable table. This is illustrated in FIG. 5. According to the present invention, the table 14 is provided with a guide and snap mechanism cooperating with counter parts 15 at the scanner for accurately positioning of the table 14 with respect to the scanner. Preferably, the height of the table surface is adjustable.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1-4. (canceled)

5. An original sheet holder in a transport scanning system, the original sheet holder for holding a set of original sheets for manually inserting one original sheet of the set of original sheets at a time for scanning in a scanner of the transport scanning system, comprising:
the original sheet holder being positioned such that leading edges of the set of original sheets on the original sheet holder are parallel to and in a direct vicinity of an entry nip of the scanner; and
and the leading edges of the set of original sheets are directly accessible to an operator of the transport scanning system.

6. The original sheet holder according to claim 5, wherein the original sheet holder is a drawer that is mounted for sliding movement in a horizontal plane.

7. The original sheet holder according to claim 5, wherein the original sheet holder is positioned underneath the entry nip of the scanner.

8. The original sheet holder according to claim 6, wherein the original sheet holder is positioned underneath the entry nip of the scanner.

9. The original sheet holder according to claim 5, wherein the original sheet holder is an upper surface of a movable table, the table comprising a guiding mechanism that cooperates with a guiding mechanism at the scanner for accurately positioning the movable table underneath the scanner.

10. The original sheet holder according to claim 5, wherein the original sheet holder is a tilted container underneath the scanner, and an edge of the tilted container that is located adjacent to the entry nip of the scanner is higher than an edge of the tilted container that is remote from the entry nip of the scanner.

11. The original sheet holder according to claim 5, wherein the set of original sheets are supported such that an image thereon is face up, and herein an operator takes a leading edge of each of the original sheets and turns the original sheet over such that the image is face down when being fed through the scanner.

12. A transport scanning system, comprising:
a scanner, said scanner having at least one pair of rollers forming an entry nip for feeding an original sheet of a set of original sheets therethrough; and
an original sheet holder, the original sheet holder for holding the set of original sheets such that leading edges of the set of original sheets are parallel to and in a direct vicinity of the entry nip of the scanner,
wherein the leading edges of the set of original sheets are directly accessible to an operator of the transport scanning system.

13. The transport scanning system according to claim 8, wherein the original sheet holder is a drawer that is mounted for sliding movement in a horizontal plane.

14. The transport scanning system according to claim 8, wherein the original sheet holder is positioned underneath the entry nip of the scanner.

15. The transport scanning system according to claim 9, wherein the original sheet holder is positioned underneath the entry nip of the scanner.

16. The transport scanning system according to claim 8, wherein the original sheet holder is an upper surface of a movable table, the table comprising a guiding mechanism that cooperates with a guiding mechanism at the scanner for accurately positioning the movable table underneath the scanner.

17. The transport scanning system according to claim 8, wherein the original sheet holder is a tilted container underneath the scanner, and an edge of the tilted container that is located adjacent to the entry nip of the scanner is higher than an edge of the tilted container that is remote from the entry nip of the scanner.
